(19) United States
(12) Patent Application Publication
(10) Pub. No.: US 2012/0066042 A1
(43) Pub. Date: Mar. 15, 2012

(54) METHOD OF COLLECTION OF INFORMATION ON AWARENESS OF CONSUMERS AND/OR USERS WITH RESPECT TO A GOOD OR SERVICE

(75) Inventor: Nikolay Melnik, Kiev (UA)

(73) Assignee: SANOFI-AVENTIS DEUTSCHLAND GMBH, FRANKFURT AM MAIN (DE)

(21) Appl. No.: 13/212,318

(22) Filed: Aug. 18, 2011

(30) Foreign Application Priority Data
Sep. 13, 2010 (UA) U201010955

(51) Int. Cl. G06Q 30/00

(52) U.S. Cl. 705/14.19

(57) ABSTRACT

The utility model relates to methods of marketing and social researches, while informing consumers and/or users in respect of a specific product or service with using telecommunications devices of communication.

The method of collecting the information on awareness of consumers and/or users in respect of a product or service includes manufacturing of materials containing the information on carrying out a survey, their distribution among prospective consumers or users of products or services, who are subscribers of devices of telecommunication means of communication, receipt of a message containing a request and/or confirmation of consent to participate in the survey from the subscriber's device of telecommunication means of communication, sending a message containing a query or task relating to a product or service to the subscriber's device of telecommunication means of communication, receipt of a message containing the subscriber's reply to the query or task relating to a product or service from the subscriber's device of telecommunication means of communication. The subscriber's reply to the query or task relating to a product or service is also assessed, a message containing the information about providing the subscriber with an award according to the results of the subscriber's reply to the query and/or task is sent, a database containing at least the information about the subscribers that made a request to participate in the survey is formed.

Use of the claimed method shall provide the obtaining of information on awareness of prospective consumers and/or users in respect of a specific product or service, in particular, medications, medical devices, medical equipment, diagnostic methods, treatment, prevention, rehabilitation, or medical or pharmaceutical services while informing the consumers and/or users of a specific product or service.

### CROSS REFERENCE TO RELATED APPLICATIONS

The present application claims priority to Ukrainian Patent Application No. u201010955 filed Sep. 13, 2010, the entire contents of which are incorporated herein by reference.

### FIELD OF INVENTION

Thins invention relates to methods of marketing and social research, while informing consumers and/or users with respect to a particular good or service with using telecommunications devices for communication, and may be used for creation of a database of prospective customers and/or users of a particular good or service, advertising of users of a certain good or service as well as for transmission of information materials relating to a particular product or service to prospective consumers and/or users.

### BACKGROUND

Many methods are known for the collection of information on awareness of consumer and/or users in respect of a good or service, among which the following ones are closest at the aggregate of essential features.

It is known to collect information on awareness of consumers and/or users in respect of a good, which includes assigning an individual code to each of the goods or services, the carrying out of a survey among participants - subscribers of mobile communication devices through the distribution of goods or services with an individual code, the receipt of a notice containing the answer of a subscriber with information on a good, if the subscriber acquires the good, or a service, should the subscriber use it, from the subscriber's mobile communication device, the formation of a database by subscribers' responses received, the splitting of the database into separate databases according to certain types of information a customer of data collection is interested in. A similar method additionally includes a preparatory stage which involves the preliminary formation of databases according to certain types of information, filled in when the information concerning a product or service is received from subscribers, and includes an encouragement stage which assumes prize drawing among participants in the survey—customers, whose identification is made by the numbers of their mobile phones (patent of Ukraine No. 11541 for utility model “Method of marketing and social research”, published in bulletin No. 12 on 15 Dec. 2005).

### SUMMARY

The method described herein may be applied to a quite broad spectrum of marketing or social research carried out on a specific product or service. The disadvantage of the well-known method is relatively insufficient motivation of participants in the survey—mobile communication device subscribers—due to the mandatory requirement to purchase a specific product or service and the need to independently send an initial notice containing the reply of a subscriber with the information about a products or service. Besides, in the method described the subscriber only sends a notice containing the reply without getting the specific information regarding the same product or service on his mobile communication device, which would be an extra incentive for him in using the method and also would act as a source of information such as improvement of professional knowledge, particularly in that industry to which the product or service belongs.

In one embodiment of the instant invention the method of collecting information on awareness of consumers and/or users in respect of a product or service, which includes manufacturing of audio visual text materials of advertising and/or informative and/or entertaining nature, containing the information about carrying out the survey, their distribution among prospective consumers or users of products or services, who are subscribers of mobile communication devices, receipt of a message containing a request and/or confirmation from the subscriber's mobile communication device of receiving the message from the wireless data exchange module which is installed permanently or moved by a motor vehicle, sending a message which content is related to a specific product or service to the subscriber's mobile communication device. When doing this, a statistical database on communication sessions with the subscriber is formed at the same time (patent of Ukraine No. 31149 for utility model “Method of Data Exchange”, published in bulletin No. 6 on 25 Mar.2008).

According to the embodiment, it may be carried out the collection of information on awareness of consumers and/or users in respect of a product or service with further formation of a database, the informing of consumers about a specific product or service and providing of useful information about a specific product or service in files sent by wireless data exchange module. The disadvantage of the prototype is a relatively narrow scope conditioned by use of connection of the wireless data exchange module and the subscriber's mobile communication device, not allowing to use this method, for example, for collection of information through the Internet or getting by a user the information remotely not in the time when the wireless data exchange module is active, or by the need for the subscriber to be within the working range of this module or generally by the necessity for the subscriber to have a mobile communication device with him. At the same time only sending the subscriber a message thematically related to a specific product or service to the subscriber's mobile device does not allow enhancing the motivation of the subscriber to further get information about a specific product or service.

The objective of ensuring the obtaining of information on awareness of prospective consumers and/or users in respect of a specific product or service in particular, medications, medical devices, medical equipment, diagnostic methods, treatment, prevention, rehabilitation, medical or pharmaceutical services, while informing the consumers and/or users of a specific product or service, is taken as basis of the utility model.

The objective set is achieved by that in the method of collection of information on awareness of consumers and/or users in respect of a specific product or service, which involves the manufacturing of audio visual text materials of advertising and/or informative and/or entertaining nature, containing the information about carrying out the survey, their distribution among prospective consumers or users of products or services, who are subscribers of devices of telecommunication means of communication, receipt of a message containing a request and/or confirmation of consent to participation in the survey from the subscriber's device of telecommunication means of communication, sending a message containing a query or task relating to a product or service to the subscriber's device of telecommunication means of communication, receipt of a message containing the subscriber's reply to the query or task relating to a product or service from the subscriber's device of telecommunication means of communication it is assessed, according to the utility model, the subscriber's reply to the query or task relating to a product or service, a message containing the information about providing the subscriber with an award according to the results of the subscriber's reply to the query and/or task is sent, a database containing at least the information about the subscribers that made a request to participate in the survey is formed.

A subscriber's mobile terminal may be used as a device of telecommunication means of communication.

A subscriber's fixed-line telephone terminal may be used as a device of telecommunication means of communication.

A personal computer with access to the Internet may be used as a subscriber's device of telecommunication means of communication by sending and receiving electronic messages.

A personal computer with access to the Internet may be used as a subscriber's device of telecommunication means of communication by sending and receiving messages through electronic forms posted on the web-page of website containing information about a product or service.

A personal computer with access to the Internet may be used as a subscriber's device of telecommunication means of communication by sending and receiving messages through an interactive web-site for communication of Internet users.

Text or multimedia messages of the mobile communication network may be used as messages.

It is also may be sent messages containing the information about providing a subscriber with an award as recharging the subscriber's account in the mobile communication network.

It is also may be sent messages containing queries and/or tasks on medications, medical devices, medical equipment, diagnostic methods, treatment, rehabilitation, prevention, medical or pharmaceutical services.

It is also may be sent messages containing queries and/or tasks of clinical nature o medications, medical devices, medical equipment, diagnostic methods, treatment, prevention, rehabilitation, medical or pharmaceutical services.

There are cause-effect relations between the aggregate of essential features of the utility model and technical result, which is achieved.

The manufacturing of audio visual text materials of advertising and/or informative and/or entertaining nature, containing the information about carrying out the survey and their distribution among prospective consumers or users of products or services, who are subscribers of devices of telecommunication means of communication, allows the preliminarily informing of prospective consumers or users of products or services about a possibility to get information relating to a specific product or service through participation in the survey, about provision of a subscriber with an award according to the results of the subscriber's reply to the query and/or task on survey.

The receipt of a message containing a request and/or confirmation of consent to participation in the survey from the subscriber's device of telecommunication means of communication, sending a message containing a query or task relating to a product or service to the subscriber's device of telecommunication means of communication and receipt of the subscriber's reply to the query or task relating to a product or service from the subscriber's device of telecommunication means of communication enable to ensure the collection of information on awareness of consumers and/or users in respect of a product or service to form a database containing at least the information about the subscribers that made a request to participate in the survey and to ensure the receipt of information by a subscriber of device of telecommunication means of communication as a prospective consumer or user on specific products or services, in particular for his learning, getting professional knowledge by him etc.

The performance of assessment of a subscriber's reply to a query and/or task relating to a product or service and sending of a message containing the information about providing the subscriber with an award according to the results of the subscriber's reply to the query and/or task enables to raise a level of encouragement of subscribers of device of telecommunication means of communication as prospective consumers or users to participation in the survey and to prolong the subscribers' participation in the survey as well as to expand the options of collecting the information on awareness of consumers and/or users in respect of a product or service.

The formation of a database containing at least the information about the subscribers that made a request to participate in the survey enables to get a database that may be used for communication with the subscribers by sending out advertisement messages (at a subscriber's consent etc.).

The usage, as a device of telecommunication means of communication, of a subscriber's mobile terminal or a subscriber's fixed-line telephone terminal or a personal computer with access to the Internet by sending and receiving electronic messages or a personal computer with access to the Internet by sending and receiving messages through electronic forms posted on the web-page of website containing information about a product or service, or a personal computer with access to the Internet by sending and receiving messages through an interactive web-site for communication of Internet users enables to expand the scope of the claimed method and to raise a level of encouragement of subscribers of devices of telecommunications means of communication.

The usage, as messages, of text or multimedia messages of the mobile communication network enables to transmit text, graphic or multimedia information on a product or service, which will increase a level of encouragement and informing of subscribers.

The sending of a message providing a subscriber with an award such as recharging the subscriber's account in the mobile communication network, enables to increase a level of encouragement of a subscriber and simplifies the implementation of the method.

The sending of a message containing queries and/or tasks concerning medications, medical devices, medical equipment, diagnostic methods, treatment, prevention, rehabilitation, medical or pharmaceutical services enables to implement the method of collecting the information on awareness of consumers and/or users in respect of specific products or services, particularly in medical or pharmaceutical industries, as well as to establish a telecommunication channel for provision of information to physicians of various specialties, medical technicians, pharmacists and pharmaceutical chemists, for improvement of their professional knowledge relating to the exercising of professional duties in the medical and pharmaceutical industry, which results in arrangement of remote learning.

The usage of tasks of clinical nature concerning of medications, medical devices, medical equipment, diagnostic methods, treatment, prevention, rehabilitation, medical or pharmaceutical services enables to increase a level of encouragement of subscribers who can be physicians of various specialties, medical technicians, pharmacists and pharmaceutical chemists and to improve the learning by them of information that they receive along with a message containing queries or tasks concerning a product or service because the subscribers have to not only provide a positive or negative reply to the queries or tasks concerning a product or service concerning products or services, but to apply their knowledge and skills, especially on account of use of a specific product or service if consumers and/or users are familiar with them. At the same time, the information on awareness of a subscriber or a group of subscribers in respect of a specific product or service may be stored on forming a database.

### DETAILED DESCRIPTION

To explain the essence of this invention, an example of specific implementation of the method of collecting the information on awareness of consumers and/or users in respect of a product or service is given below. The given example of specific implementation of the method limits in no way the scope of the claims set forth in the formula, and only explains the essence of the invention.

Thus in the specified method the term “consumer of products or services” implies the end consumer of a product or service, such as a buyer of medications or a visitor to a medical institution when the method is used in the medical and pharmaceutical industry. The term “user of products or services” implies a person who should be aware of a product or service through his activities, such as physicians of various specialties, medical technicians, pharmacists and pharmaceutical chemists when the method is used in the medical and pharmaceutical industry. The term “awareness of a product or service” implies awareness, availability of certain knowledge and skills with consumers and/or users when using specific products or services.

The claimed method is implemented, for example, in the pharmaceutical industry as follows.

First, it is produced some materials of advertising and/or informative and/or entertaining nature, containing the information about carrying out the survey. Those materials may be printed materials, in particular booklets, catalogues, brochures or video products, such as a commercial or e-mail on the Internet and so on. Then the materials produced are distributed among prospective consumers or users of products or services in places of holding the thematic conferences or workshops, through the mass media or Internet. The prospective consumers or users of products or services as subscribers of devices of telecommunication means of communication are therefore made informed about carrying out the survey.

A database containing messages with a query or task concerning a product or service is also preliminarily formed. Such queries or tasks may be, for example, use of medications or biologically active additives (BAA), curative cosmetics, medical devices, including all aspects, i.e. manner of use, indications for use, contraindications, distinctive features of use, dosages etc), other aspects relating to use of the above, their use for various diseases and conditions that require medical intervention. Queries or tasks may relate to diagnosis and treatment of diseases and conditions that require medical advice and intervention, consultation of pharmaceutical chemists or pharmacists, should a doctor's advice be optional (according to the principles of appropriate self-treatment with medicinal preparations dispensed without prescriptions, BAA or curative cosmetics).

### Example of a Query or Task No. 1

Query: spectrum of hepatoprotective activity of the medication (product name) allows its use for patients with the following diagnoses:

Options of reply:
hepatic steatosis
toxic affection of liver
acute and chronic hepatitis
psoriasis
radiation syndrome
cirrhosis
all listed above.

### Example of a Query or Task No. 2

Query: a patient is of 30 years old, diagnosed with antibiotic-associated diarrhoea. What dose of the medication (product name) would you prescribe for this patient?

Options of reply:
1 vial 2-3 times a day
1 vial once a day
2 vials once a day.

Then the subscriber sends a message containing a request to a service provider, such as a mobile communication operator, from a mobile terminal as a text message (SMS, Short Message Service) or a multimedia message (MMS, Multimedia Message Service).

Then the subscriber is sent a message containing a query and the subscriber's reply to the query or task in respect of a product or service is received from the subscriber's device of telecommunication means of communication, if he takes part in the survey. Next, the subscriber's reply to the query and/or task in respect of a product or service is assessed by comparing the subscriber's reply with the correct replies and assigning to the mobile communication subscriber an appropriate award through a mobile operator, such as points equivalent to currency unit or as recharging the subscriber's account in the mobile communications network.

Then a message containing the information about providing the award is sent to the subscriber. A database containing the information about the subscribers made a request to participate in the survey with computer's data storage means, such as electronic storage media is also be formed. Those data may be either the numbers of subscribers' mobile terminals and their personal data, if personification of subscribers has been previously done, or the survey data for each of the subscribers or a group of subscribers and so on. The database so formed may be further used for next surveys, informing of consumers and/or users or advertising mailing at consent of a subscriber.

Thus, use of the claimed method shall provide the obtaining of information on awareness of prospective consumers and/or users in respect of a specific product or service, in particular, medications, medical devices, medical equipment, diagnostic methods, treatment, prevention, rehabilitation, or medical or pharmaceutical services while informing the consumers and/or users of a specific product or service. Thus, a subscriber gains necessary knowledge about products or services for use in his professional activities.

1. A method of collecting information on awareness of consumers and/or users with respect to a product or service comprising,
manufacturing audio visual text materials of advertising and/or informative and/or entertaining nature containing;
the information about carrying out a survey, and
the distribution among prospective consumers or users of products or services, who are subscribers of devices of telecommunication means of communication;
receiving a message containing a request and/or confirmation of consent to participate in the survey from the subscriber's device of telecommunication means of communication;
sending a message containing a query or task relating to a product or service to the subscriber's device of telecommunication means of communication;
receiving a message containing the subscriber's reply to the query or task relating to a product or service from the subscriber's device of telecommunication means of communication;
assessing the subscriber's reply to the query and/or task relating to a product or service;
sending a message containing information about providing the subscriber with an award according to the results of the subscriber's reply to the query and/or task; and
forming of a database containing at least the information about the subscribers that made a request for participation in the survey.

2. The method as claimed in claim 1 further characterized in that a subscriber's mobile terminal is used as a device of telecommunication means of communication.

3. The method as claimed in claim 1 further characterized in that a fixed-line telephone terminal is used as a device of telecommunication means of communication.

4. The method as claimed in claim 1 further characterized in that a personal computer with access to the Internet is used as a subscriber's device of telecommunication means of communication by sending and receiving electronic messages.

5. The method as claimed in claim 1 further characterized in that a personal computer with access to the Internet is used as a subscriber's device of telecommunication means of communication by sending and receiving messages through electronic forms posted on a web-page of a website containing information about a product or service.

6. The method as claimed in claim 1 further characterized in that a personal computer with access to the Internet is used as a subscriber's device of telecommunication means of communication by sending and receiving messages through an interactive web-site for communication of Internet users.

7. The method as claimed in claim 2 further characterized in that text or multimedia messages of the mobile communication network may be used as messages.

8. The method as claimed in claim 2 further characterized in that the sending of a message containing the information about providing the subscriber with an award as recharging the subscriber's account in the mobile communication network is carried out.

9. The method as claimed in claim 1 further characterized in that the sending of a message containing a query and/or task on medications, medical devices, medical equipment, diagnostic methods, treatment, rehabilitation, prevention, medical or pharmaceutical services is carried out.

10. The method as claimed in claim 1 further characterized in that the sending of a message containing a query and/or task of clinical nature on medications, medical devices, medical equipment, diagnostic methods, treatment, rehabilitation, prevention, medical or pharmaceutical services is carried out.
